(19) United States
(12) Patent Application Publication
(10) Pub. No.: US 2015/0371804 A1
(43) Pub. Date: Dec. 24, 2015

(54) CHIP TYPE FUSE

(71) Applicant: KOA CORPORATION, Ina-shi (JP)

(72) Inventors: Takahiro Ishikawa, Ina-shi (JP); Hiroshi Ichikawa, Ina-shi (JP); Chika Ito, Ina-shi (JP)

(73) Assignee: KOA CORPORATION, Ina-shi (JP)

(21) Appl. No.: 14/739,119

(22) Filed: Jun. 15, 2015

(30) Foreign Application Priority Data
Jun. 19, 2014 (JP) 2014-126036

(51) Int. Cl. H01H 85/20; H01H 85/04

(52) U.S. Cl. CPC H01H 85/2045; H01H 85/04; H01H 2239/034

(57) ABSTRACT

Provided is a chip type fuse excellent in resistance to climatic condition, where the fuse is able to operate stably under high temperature and high humidity environments. The fuse includes an insulative substrate; an under-glass layer formed on the insulative substrate; a fuse element formed on the under-glass layer; a pair of electrodes formed at both end sides of the fuse element; and an over-glass layer covering at least a fusing section of the fuse element; wherein the fuse element includes a layer where a first metal layer and a second metal layer are piled up, and a barrier layer consisting of a third metal layer, which covers the first metal layer and the second metal layer with width that is wider than the width of the first metal layer and the second metal layer. The third metal layer overwraps the second metal layer intervening and the first metal layer.

### TECHNICAL FIELD

The invention relates to circuit protection elements, particularly chip type fuses having a fuse element, which fuses by a prescribed overcurrent.

### BACKGROUND ART

The chip type fuse has previously been known (for example, see laid-open Japanese patent publication 2008-52989). The chip type fuse includes an under-glass layer formed on upper surface of an insulative substrate, a pair of thick film electrodes formed on the glass layer, a fuse element of thin film or thick film formed so as to connect to the thick film electrodes, an over-glass layer formed on the fuse element, and a resin protective layer formed on upper surface of the glass layer.

According to the chip type fuse, because of the fuse element covered by under and over glass layers, an effect that heat from the fuse element is stored therein is caused, and the fuse element can be fused with a small overcurrent at high speed.

In the chip type fuse, the fuse element is covered by the glass layers on both sides for improving fusing characteristics, and this is basing on an assumption of reaction with dry gaseous oxygen in the atmosphere. However, under an humidity environment, there is a problem that boric oxide of the glass element becomes boric acid, and it begins to melt on the fuse element, and corroding the fuse element pattern of Cu. Additionally, because fuse element pattern is formed by Cu of its surface, movement of Cu is promoted when exposed to hot temperature environment, then upheaval of Cu along grain boundary may be caused as the result, thus there is a possibility that the fuse element may be damaged by long term use in the environment.

### SUMMARY OF INVENTION

### Technical Problem

The invention has been made basing on above-mentioned circumstances. Therefore object of the invention is to provide a chip type fuse excellent in resistance to climatic condition, where the fuse is able to operate stably under high temperature and high humidity environments.

### Solution to Problem

The chip type fuse of the invention includes an insulative substrate; an under-glass layer formed on the insulative substrate; a fuse element formed on the under-glass layer; a pair of electrodes formed at both end sides of the fuse element; and an over-glass layer covering at least a fusing section of the fuse element; wherein the fuse element includes a layer where a first metal layer and a second metal layer are piled up, and a barrier layer consisting of a third metal layer, which covers the first metal layer and the second metal layer with width that is wider than the width of the first metal layer and the second metal layer.

Though, there was a problem that over-glass layer includes borosilicate glass that contains boron for lowering melting point, boric oxide of the glass layer becomes boric acid in high temperature and high humidity environments, and it begins to melt on the fuse element, and corroding the fuse element pattern of Cu etc. According to the invention, because the chip type fuse includes a barrier layer consisting of a third metal layer, which covers the fuse element pattern, then the fuse element pattern can be prevented from being corroded.

Further, though metal layer of the Cu etc. excellent in conductivity tends to fluid in the fuse element in high temperature environment, the barrier layer can control this movement, thus resistance to heat can be improved. Therefore, the chip type fuse excellent in resistance to climatic condition, which operates stably in high temperature and high humidity environments, can be obtained.

### BRIEF DESCRIPTION OF DRAWINGS

FIG. 1 is a cross-sectional view of the chip type fuse of an embodiment of the invention along AA lines in FIG. 2 and FIG. 3.

FIG. 2 is a plan view of the chip type fuse of FIG. 1 after forming the over-glass layer.

FIG. 3 is a plan view of the chip type fuse of FIG. 1 after forming protective resin layer.

FIG. 4 is an enlarged cross-sectional view of the chip type fuse along BB lines in FIG. 2 and FIG. 3.

FIG. 5 is a graph showing a result of 85° C./85% humidity and power on testing.

FIG. 6 is a graph showing a result of 175° C. resistance to heat storage testing.

FIG. 7 is a graph showing a result of 134° C./95% humidity and power on testing.

### DESCRIPTION OF EMBODIMENTS

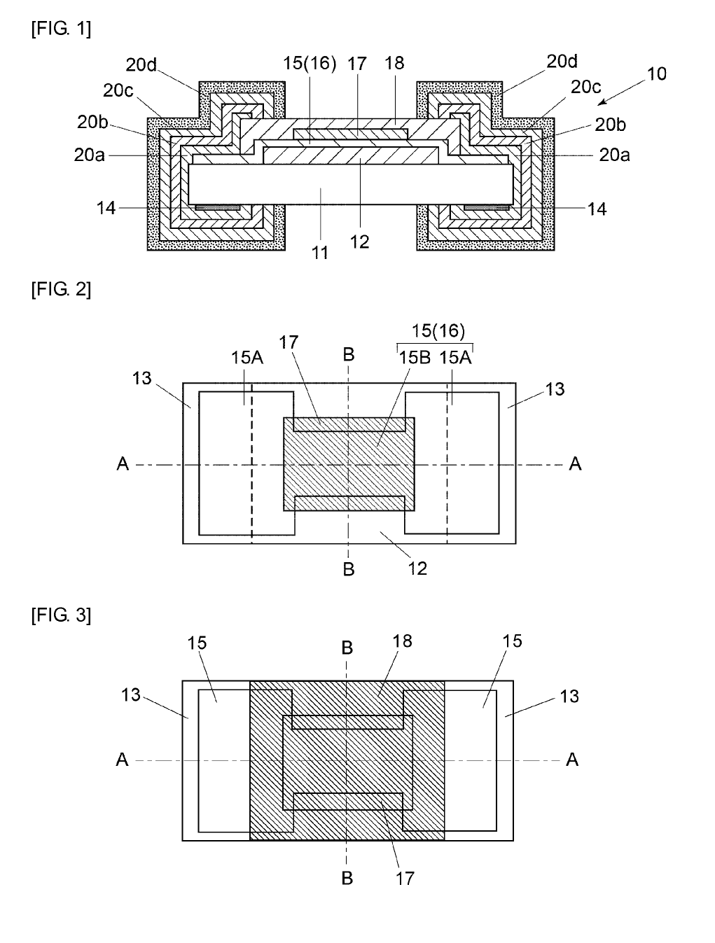

Embodiments of the invention will be described below with referring to FIG. 1 through FIG. 7. Like or corresponding parts or elements will be denoted and explained by same reference characters throughout views.

FIGS. 1-4 show a structure of the chip type fuse of an embodiment of the invention. The fuse 10 includes an insulative substrate 11, such as alumina etc., an under-glass layer 12 formed on the substrate, a pair of electrodes 13 formed on both end sides of the glass layer 12 at least a portion of the electrodes piled up on the glass layer, a fuse element 15 formed between the electrodes 13, and an over-glass layer 17 covering at least a fusing section 15B of the fuse element 15. The fuse element 15 consisting of wide-width electrode sections 15A and narrow-width fusing section 15B connecting to the electrode sections 15A is integrally formed. The under-glass layer 12 is formed below the fusing section 15B of the fuse element 15.

The fuse element 15 consists of first metal layer 15a formed by sputtering and second metal layer 15b also formed by sputtering piled up on the layer 15a. First metal layer 15a consists of Cr layer having film thickness of, for instance, about 500 Å, and second metal layer 15b consists of Cu layer having film thickness of, for instance, about 1-3 μm. Here, the current flows mainly through the second metal layer consisting of Cu layer of higher conductivity. And, the first metal layer 15a mainly plays the role to connect the second metal layer 15b on the under-glass layer 12.

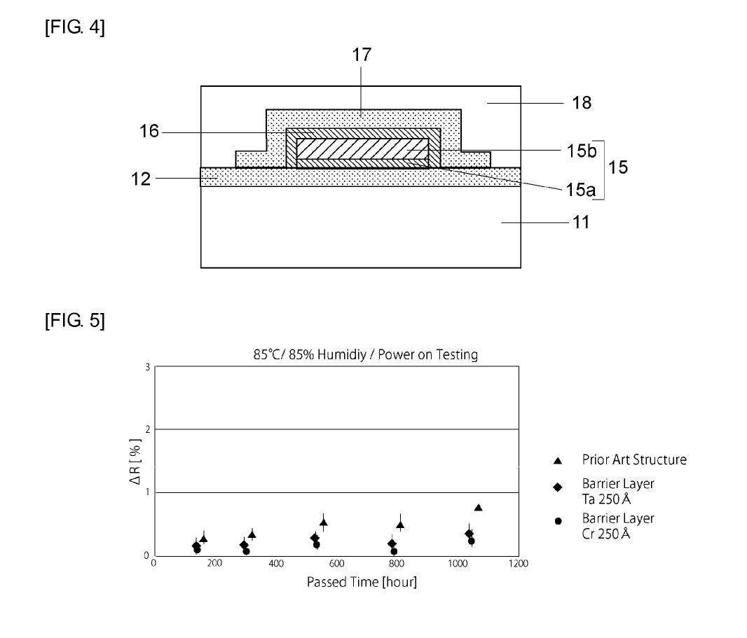

The fuse element layer 15 includes a barrier layer 16 consisting of the third metal layer, which covers the first metal layer 15a and the second metal layer 15b with width that is wider than the width of the first metal layer 15a and the second metal layer 15b. That is, the barrier layer 16 consisting of the third metal layer overwraps the second metal layer 15b intervening and the first metal layer 15a (see FIG. 4). In this embodiment, the fuse element 15 includes the first metal layer 15a, the second metal layer 15b, and the barrier metal layer 16. The third metal layer as the barrier layer 16 preferably consists of Ta or Cr, and formed by sputtering. However, Ni, NiCr (6:4), NiCr (8:2), or Ti, etc. shows barrier effect, and can be used as the barrier layer. It is preferable that film thickness of the barrier layer 16 is in range of 50-2000 Å.

Over-glass layer 17, who's width is narrower than width of electrode section 15A, is formed at an area for covering the fusing section (fuse element) 15B of the fuse element 15. Accordingly four surfaces of the second metal layer 15b consisting of Cu, which becomes main current route, are surrounded by barrier layer 16 consisting of Ta or Cr etc. and first metal layer 15a consisting of Cr. Further, the fuse element 15 consisting of first and second metal layers and the barrier layer 16 consisting of third metal layer are surrounded by under-glass layer 12 and over-glass layer 17 (see FIG. 4).

The protection layer 18 consisting of epoxy resin etc. is disposed at upper side of the over-glass layer 17. The end face electrodes connecting front electrode 13 and rear electrode 14 is formed at end faces of insulative substrate 11 and under-glass layer 12. The plated electrode layers 20a, 20b, 20c, 20d, which are suitable for surface mounting, are formed on exposed surfaces of end face electrodes and front and rear electrodes 13, 14 (see FIG. 1). Plated electrode layer 20a consists of Ni plated layer, plated electrode layer 20b consists of Cu plated layer, plated electrode layer 20c consists of Ni plated layer, and plated electrode layer 20d consists of Sn plated layer. Such structure is similar to usual chip type parts, thus the chip type fuse 10 is one of chip type parts, available for surface mounting.

Low melting point glass is used for over-glass layer 17, because of restriction that the later processed must be processed at the lower temperature. In general, the low melting point glass contains components such as boron, lead, or bismuth etc. for lowering the melting point. One of these typical components is a borosilicate glass. The borosilicate glass takes moisture in under a humidity environment. The following reactions take place for producing boric acid (H₃BO₃), which corrodes Cu. Then the fuse element consisting of Cu corrodes under the high humidity environment.

B₂O₃(glass)+3H₂O→2H₃BO₃ (boric acid)

CuO+2H₃BO₃(boric acid)→Cu(BO₂)₂+3H₂O

That is, in the high humidity environment, an outside water molecule (moisture) enters into the product and when it reaches the fuse element, the fuse element corrodes by the oxidation action by moisture and boron components. Such mechanism can be assumed. Therefore, because barrier layer 16 guards the attack of the water molecule to Cu in fuse element layer 15, corrosion by the moisture intrusion to Cu is prevented and resistance to humidity can be improved.

Further, in the high temperature environment, Cu particles in the fuse element 15 are activated by the thermal energy, and they enter to the state that moves easily. Accordingly, because Cu particles on a surface of the fuse element tend to cause transfer phenomenon, the barrier layer 16 is formed so as to cap the surface and to stop movement of Cu particles on the fuse element. Therefore, according to the barrier layer 16, upheaval phenomenon etc. of Cu is prevented, and resistance to heat can be improved. As a result, because the barrier layer 16 can be effective to two kinds of failure mechanisms, the barrier layer 16 can improve resistance to humidity and resistance to high temperature, and an excellent chip type fuse in resistance to climatic condition is obtained.

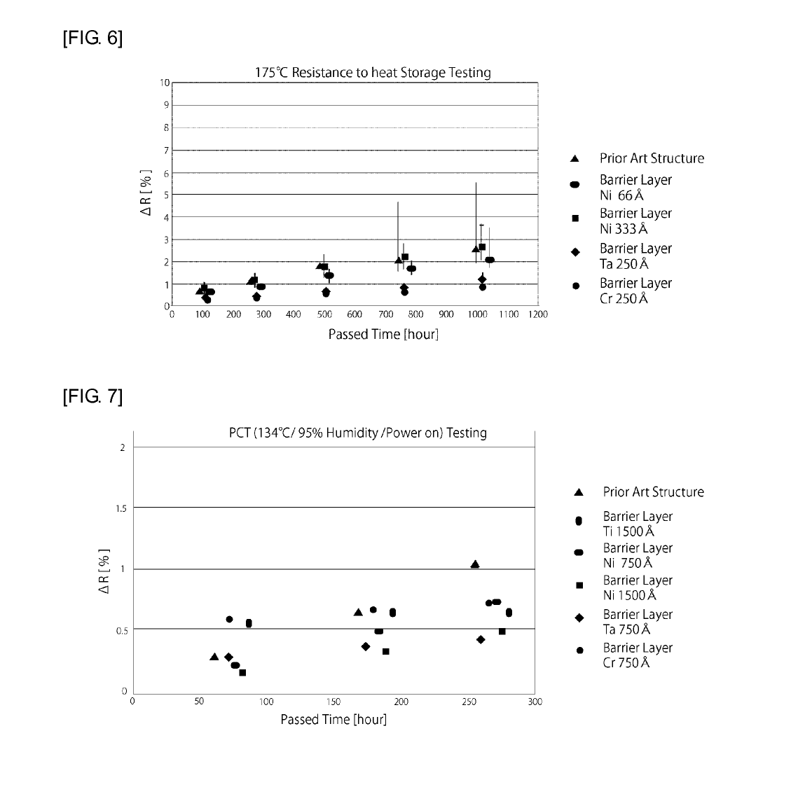

FIG. 5 shows a result of 85° C. temperature/85% humidity/power on test. The test was carried out by introduction of the barrier layer 16 and not. As a result, in case of the barrier layer 16 being Ta or Cr, domination of resistance to climatic condition has been confirmed to prior art structure (no barrier layer). That is, samples are extracted after the test, and whether corrosion of fuse element layer 15 has been caused or not was confirmed. As the result, it was confirmed not to have caused corrosion other than prior art structure (no barrier layer). However, according to kinds of material of the barrier layer, there is some material, which is not effective to stop corrosion. Thus, when carrying out introduction of the barrier layer, it is necessary to choose the material for the barrier layer.

In case of carrying out the resistance to climatic condition test, according to prior art structure (no barrier layer), corrosion portion on the fuse element was found. However, according to barrier layer 16 consisting of Ta or Cr (both thickness: 250 Å), corrosion was not found, change of resistance value is a little, then effect of the barrier layer was confirmed. According to barrier layer 16 consisting of Ni (thickness: 333 Å), corrosion was not found, and effect of the barrier layer was confirmed. Also, according to barrier layer 16 consisting of Ni, NiCr (6:4), NiCr (8:2), or Ti, it is thought that resistance to humidity improves.

On the other hand, when barrier layer 16 consists of Cr, or Ta, it is effective for the particle movement phenomenon on Cu surface under high temperature environment. By forming barrier layer 16 consisting of Cr or Ta (Both 250 Å) on a surface of the fuse element layer 15 consisting of Cu, activity of Cu particle in the fuse element layer can be decreased, and long-term operation characteristic can be improved.

For this confirmation, five kinds of samples (prior art structure, barrier layer structure, that is, Ni (66 Å), Ni (333 Å), Ta (250 Å), and Cr (250 Å)) are made. And, the samples are left in 175° C. environmental chamber, and ΔR (resistance change) was observed (see FIG. 6). After 1000 hours passed, as to prior art structure (no barrier layer), resistance change was large (Max.=5.5%) and the difference was also large. In contrary to this, any one of samples that has the barrier layer 16, shows better characteristics than the prior art structure.

The best material for the barrier layer was Cr, which shows small resistance change (Max.=1.11%) and small difference. As to Ta, it is similar. At this point, the sample is extracted, and the fuse element was observed. As to the barrier layer structure of the above materials, upheaval of Cu was not found. From the above-mentioned result, the effect on improving resistance to high temperature has been confirmed.

FIG. 7 shows a result of PCT test. The PCT test is an abbreviation of “pressure”, “cooker”, “test”, and a kind of an accelerated life test. It is a severe test that impresses 8% of ratings current under high temperature of 134° C. and pressurized steam atmosphere of 95% humidity. As a result, by extremely increasing pressure of water vapor inside of test chamber than partial water vapor pressure of device under test, infiltration of moisture into device under test can be shortened in time. Thus, an evaluation of resistance to humidity and resistance to heat of devices can be carried out in a short time.

As to resistance change (ΔR) after 50 hours or more passed, barrier layer Cr 750 Å ( mark) and barrier layer Ti 1500 Å are the smallest, and, next, barrier layer Ta 750 Å (♦ mark) is small. And, barrier layer Ni 1500 Å (▪ mark) is larger than these, and barrier layer Ni 750 Å is a little larger than Ni 1500 Å. However, the result that resistance change (ΔR) of any sample having barrier layer is smaller than that of the prior art structure (no barrier layer) has been obtained.

From the above result, by including the barrier layer, resistance to climatic condition of the chip type fuse can be improved, and thin film such as Cr, Ta, or Ti etc. is especially effective as the barrier layer. Moreover, Ni, NiCr (6:4), and NiCr (8:2), etc. were studied. The movement of Cu particles is not observed upon these devices. And, it is thought that resistance change (AR) of these materials is smaller than prior art structure as shown in FIG. 7, and these materials are also effective as the barrier layer.

Although embodiments of the invention has been explained, however the invention is not limited to above embodiments, and various changes and modifications may be made within scope of the technical concepts of the invention.

### INDUSTRIAL APPLICABILITY

The invention can be suitably used for chip type circuit protection elements, especially for chip type fuses.

1. A chip type fuse, comprising:
an insulative substrate;
an under-glass layer formed on the insulative substrate;
a fuse element formed on the under-glass layer;
a pair of electrodes formed at both end sides of the fuse element; and
an over-glass layer covering at least a fusing section of the fuse element;
wherein the fuse element includes a layer where a first metal layer and a second metal layer are piled up, and a barrier layer consisting of a third metal layer, which covers the first metal layer and the second metal layer with width that is wider than the width of the first metal layer and the second metal layer.

2. The chip type fuse of claim 1, wherein the third metal layer overwraps the second metal layer intervening and the first metal layer.

3. The chip type fuse of claim 1, wherein the fuse element includes the first metal layer consisting of Cr and the second metal layer consisting of Cu.

4. The chip type fuse of claim 1, wherein the third metal layer is the barrier layer consisting of any one of Ta, Cr, Ni, NiCr, or Ti.

5. The chip type fuse of claim 1, wherein thickness of the barrier layer is in the range of 50-2000 Å.
